(19) United States
(12) Patent Application Publication
(10) Pub. No.: US 2008/0004089 A1
(43) Pub. Date: Jan. 3, 2008

(54) Inline Cable Adapter for Dissimilar Radio and Headset Combinations

(76) Inventors: Simon R. Huizer, Brick, NJ (US); Christopher J. Pilla, Freehold, NJ (US); Christopher C. Wantuck, Red Bank, NJ (US)

Correspondence Address: DIEHL SERVILLA LLC, 77 BRANT AVE, SUITE 210, CLARK, NJ, 07066, US

(21) Appl. No.: 11/468,948

(22) Filed: Aug. 31, 2006

Related U.S. Application Data
(60) Provisional application No. 60/817,944, filed on Jun. 30, 2006.

(51) Int. Cl. H04M 1/00

(52) U.S. Cl. 455/575.2

(57) ABSTRACT

An inline adapter allowing electrically dissimilar headset to be adapted to different radios is disclosed. This provides privacy and/or radio concealment, with a convenient and versatile jumper-like device. The need for batteries or external power supplies is eliminated by using the power normally dedicated to supplying a ceramic microphone pre-amp, to an amplifier used to boost the output of a dynamic microphone.

### CROSS-REFERENCE TO RELATED APPLICATIONS

This application claims the benefit of and priority to U.S. Provisional Application No. 60/817,944 filed Jun. 30, 2006, which is incorporated herein by reference.

### STATEMENT REGARDING FEDERALLY SPONSORED RESEARCH OR DEVELOPMENT

The invention was funded under a contract with an agency of the United States Government. The name of the U.S. Government agency is CERDEC and the Government contract number is DAAB07-03F-0095.

### FIELD OF INVENTION

This cable adapter relates to mobile communications, specifically to the adaptation of dissimilar radios and headsets.

### BACKGROUND OF THE INVENTION

The use of portable radios, commonly referred to as walkie-talkies, has become a widespread and essential part of police, fire fighters, military personnel and other groups. Typically, the radios are used in their natural mode, where the microphone and speaker are an integral part of the housing. If a need such as privacy or radio concealment arises, a headset may be employed. A compatible headset is often provided with the radio or can be separately obtained.

However, in actual field conditions, numerous radios, headsets, and cables are often present. The user will often have to change radios when dismounting a vehicle equipped with a radio, for example, and proceed on foot using a small mobile radio. Unfortunately, this often necessitates of change of headset as well. The changing of headset can present several problems. First, the headset may be an integral part of a helmet or other protective headgear which may be essential to the mission at hand, and therefore not removable. Second, the changing of radio headsets requires time to make change and perform adjustments, a process that may be totally unacceptable in a time of crisis. Third, the changing of radios and headset combinations may be required several times during a mission, leading to operator fatigue, which can manifest in the temptation and actual avoidance of using the proper radio gear.

Accordingly apparatus providing improved application of appropriate radio headsets are required.

### SUMMARY OF THE INVENTION

This invention addresses the need to make rapid headset changes by providing an inline cable that adapts dissimilar radio types and headsets. This entails not only a mechanical adaptation, but also provides for the accommodation of active electronic circuitry. For example, the configuration enabled by this invention could be employed to adapt the use of a dynamic microphone headset to a radio that normally uses a condenser microphone.

Rapid deployment in extreme mobile situations requiring constant communication demands mechanical and electrical interchangeability between all communications devices. This cable adapter addresses the need to make quick changes of a single radio headset and dissimilar radio combinations.

Accordingly it is one object of the present invention to provide methods and apparatus for a quick change of a headset, radio combination that would ordinarily be incompatible.

It is another object of the present invention to provide apparatus for the rapid change over of a single headset from a radio requiring a dynamic microphone to one requiring a condenser microphone without the need to change the headset.

It is a further object of the present invention to provide for the incorporation of an active circuit amplifier without the necessity of batteries or external power supply by tapping power usually dedicated only for the microphone use.

It is another object of the present invention to provide a sleek package by concealing the electronic circuitry in the casing of the cable connector shell.

It is a further object of the present invention to provide the incorporation of an earphone connection with adjustable gain.

It is another object of the present invention to provide a method to reduce the time required to make a radio change.

### DESCRIPTION OF THE DRAWINGS

FIG. 1 illustrates one aspect of the present invention.

FIG. 2 is a schematic illustration of a cable adapter configuration in accordance with one aspect of the present invention.

FIG. 3 is a schematic illustration of another cable adapter configuration in accordance with another aspect of the present invention.

FIG. 4 is a block diagram of an adaptor circuit in accordance with a further aspect of the present invention.

FIG. 5 is an electronic schematic diagram illustrating circuitry according to one aspect of the present invention.

### DESCRIPTION OF A PREFERRED EMBODIMENT

The system and method of the present invention addresses the need for electrical compatibility between one headset and several radios. The problem addressed arises frequently, for example, in battlefield scenarios. In these scenarios, a soldier traveling in a transport vehicle may have his headset plugged into a first type of radio. When the soldier must leave the transport vehicle, the soldier may have to unplug the headset from the first type of radio in the transport vehicle and plug it into a second type of radio, for example, a mobile radio. This can be a difficult task, as the soldier may be under duress. The second type of radio may have different characteristics than the first type of radio and the headset may not perform as well as it should, potentially causing life threatening problems.

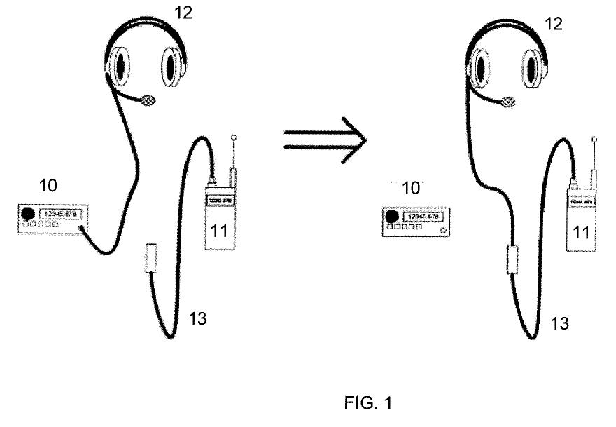

FIG. 1 shows one situation that illustrates this type of adaptation approach. In this figure, an individual is changing from a communication system 10 that is specified to operate with a dynamic type of microphone to a communication system 11 that is specified to use a condenser type microphone. In this scenario, the headset that is being worn before, during and after the transition is headset 12 which is comprised, in part, of a dynamic microphone. The headset 12 is therefore compatible with communication system 10, but is incompatible in a direct connection with communication system 11.

In accordance with one aspect of the present invention, an interconnection system 13 is always connected to communication system 11 such that the transition from communication system 10 to communication system 11, as illustrated here, requires only a simple disconnect from communications system 10 and quick reconnect to inline adapter cable 13.

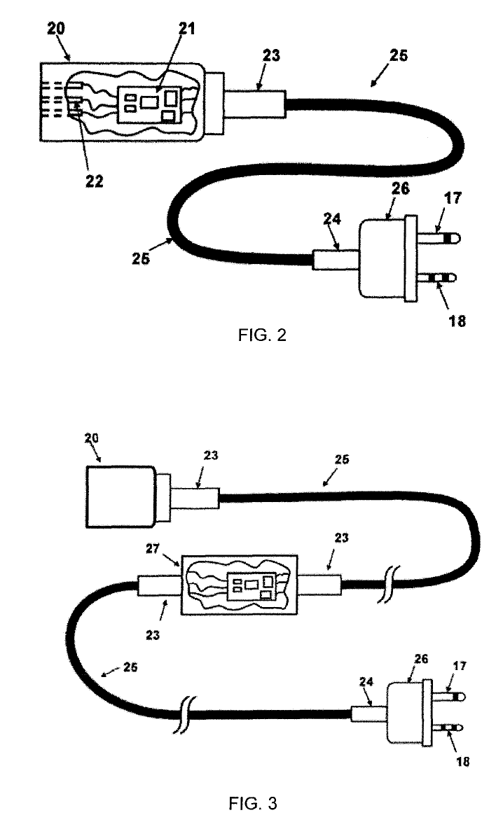

FIG. 2 shows an overall diagram of an implementation of an inline cable adapter in accordance with one aspect of the present invention. The connector 20 for the dynamic microphone contains an amplification circuit 21. The amplification circuit 21 is connected to the connector pins 22 with wire jumpers. The connector pins 22 receive a connector from a headset 12. The circuit 21 is wired to the interconnecting cable 25 and passes through a strain reliever 23. The length of the cable 25, is determined by the application, but preferably allows a radio to be belt worn while wearing the dynamic headset. Another cable strain reliever, 24, is employed to anchor the cable 25 to the radio connector 26. The radio connector 26 indicates pins for the earphone 17 and for the ceramic microphone circuit 18. Other pins can be provided as needed.

An alternative to the configuration in FIG. 2 is shown in FIG. 3. In this arrangement, the adaptor circuitry is incorporated in an in-line system resembling a capsule 27. The capsule is preferably provided with a strain relief at both ends. This arrangement is advantageous because it reduces the size and weight of the connector 20. The adaptor circuitry to match the dissimilar radios can be provided anywhere along the cable 25. For example, it can also be provided in the radio connector 26.

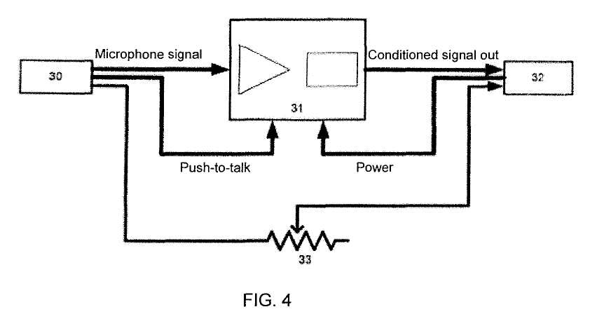

FIG. 4 presents a functional block diagram of the circuit 21 in FIG. 2. The purpose of this circuit is to match the expectations of two dissimilar radios. In this case, the circuit is used to boost the output of the dynamic microphone to mimic the signal ordinarily generated by a ceramic or condenser type microphone/pre-amp combination. In this figure, the signal from the headset microphone is input at connector 30. The signal then passes through the signal conditioner/amplifier 31. Finally, the signal presented at connector 32 is suitable for input to communications systems expecting a condenser type microphone. Power for the circuit 31 is derived from the bias provided by the communications system that is ordinarily used to energize a ceramic microphone. The “Push-to-Talk feature often incorporated in mobile radios can be accommodated by a muting function with the result that the gain in the microphone circuit is greatly reduced when not transmitting. The function is usually controlled by a button on the radio and if the radio relies on the headset to perform the actual muting, the control line for this feature in the cable can be monitored or used to control the muting function. Provision for a separate volume control for the headset earphones can also be accommodated in this circuit. In this embodiment, a simple Resistor 33 limits the current driving the earphones in the dynamic amplifier headset and thus acts as volume control. Resistor 33 is connected in series between the Communications system earphone output, attached to Connector 30, and the earphone input to the headset, attached to Connector 32. Resistor 33 can be of a pre-selected set value or an adjustable by utilizing a variable current limiting device such as the potentiometer, as shown in FIG. 4.

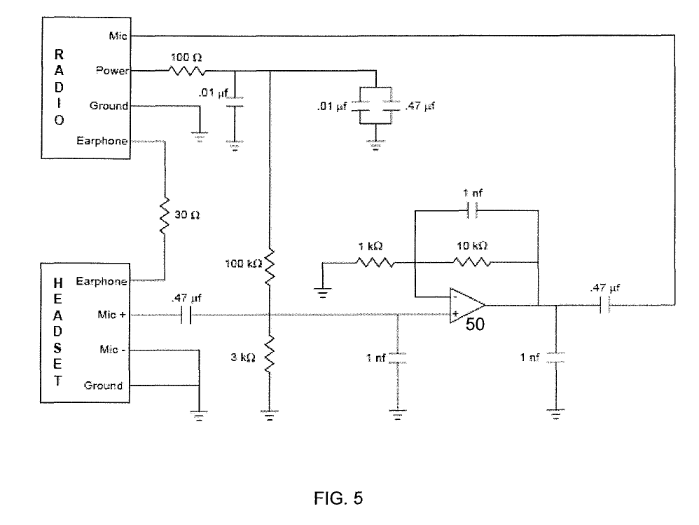

FIG. 5 is a diagram of an embodiment of an adaptor circuit in accordance with an aspect of the present invention. The MIC+ output from the headset 12 is transmitted through a 0.47 μF capacitor and through an amplifier circuit 50 for signal conditioning. The capacitor removes a DC bias that is normally output by a dynamic microphone that is not expected by a radio designed to work with a condenser type microphone. The amplifier circuit 50 adjusts the signal level of the MIC+ output from the dynamic microphone to the levels expected by a radio designed to work with a condenser type microphone. A 30 Ω resistor is provided between the earphone connectors of the radio and the headset. This resistor can also be a variable resistor to adjust the volume level. Power is preferably provided from the power output of the radio through a resistor/capacitor network, but can also be supplied by another power source, such as a battery. Other embodiments of the circuit are possible.

### Conclusion, Ramifications and Scope

The present invention extends the use of portable radios, commonly referred to as walkie-talkies by allowing electrically dissimilar headset to be used. This provides privacy and/or radio concealment, with a convenient and versatile device. Precious seconds or even minutes, in a time crisis can be gained, as well as the avoidance of operator frustration and fatigue. The need for batteries or external power supplies is eliminated by using power usually dedicated to supplying a ceramic microphone pre-amp, to an amplifier to adapt a dynamic microphone.

Although the description of the present invention contains many specifics, these should not be construed as limitations on the scope of the invention, but rather as providing examples of some presently preferred embodiments of the invention. Many other variations are possible. For example, external knobs can be provided for volume control. A spiral, retractable cable can be used instead of the basic cable discussed previously.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. An article for connecting dissimilar headsets to a radio, comprising:
a connector for a headset;
a connector for a radio, and
an adaptor circuit connected between the connector for the headset and the connector for the radio by a cable.

2. The article of claim 1, wherein the adaptor circuit is in the connector for the headset.

3. The article of claim 1, wherein the adaptor circuit is in the connector for the radio.

4. The article of claim 1, wherein the adaptor circuit is encapsulated in the cable.

5. The article of claim 1, wherein the adaptor circuit includes an amplifier circuit to adjust the signal level of a microphone output of the headset connector.

6. The article of claim 1, wherein the adaptor circuit includes a means for removing a DC bias of a microphone output of the headset connector.

7. The article of claim 5, wherein the adaptor circuit includes a means for removing a DC bias of a microphone output of the headset connector.

8. The article of claim 1, wherein the adaptor circuit can receive power from the connector for the radio.

9. A communication system, comprising:
a first radio that is designed to receive a first type of signal from a dynamic microphone;
a second radio that is designed to receive a second type of signal from a condenser microphone;
a cable connected to the second radio, the cable including an adaptor circuit that changes the first type of signal to the second type of signal; and
a headset with a dynamic microphone;
wherein the headset is connected to the first radio during a first time of operation and the headset is connected to the cable during a second time of operation.

10. The article of claim 9, wherein the adaptor circuit is in the connector for the headset.

11. The article of claim 9, wherein the adaptor circuit is in the connector for the radio.

12. The article of claim 9, wherein the adaptor circuit is encapsulated in the cable.

13. The article of claim 9, wherein the adaptor circuit includes an amplifier circuit to adjust the signal level of a microphone output of the headset connector.

14. The article of claim 9, wherein the adaptor circuit includes a means for removing a DC bias of a microphone output of the headset connector.

15. The article of claim 14, wherein the adaptor circuit includes a means for removing a DC bias of a microphone output of the headset connector.

16. The article of claim 9, wherein the adaptor circuit can receive power from the second radio.

17. The article of claim 14, wherein the adaptor circuit can receive power from the second radio.

18. A method of communicating, comprising:
removing a cable from a first radio, the cable extending from a headset with a dynamic microphone;
plugging the cable into an adapter cable; the adapter cable being plugged into a second radio that is designed to operate with a condenser microphone;
wherein the adapter cable includes circuitry that modifies a signal from the headset.

19. The method of claim 18, wherein the adaptor circuit removes a DC bias.

20. The method of claim 18, wherein the adaptor circuit adjusts the level of the signal.
